(19) United States
(12) Patent Application Publication
(10) Pub. No.: US 2026/0310222 A1
(43) Pub. Date: Oct. 8, 2026

(54) METHOD, SYSTEM, AND MEDIUM FOR CLEANING A SWIMMING POOL WALL

(71) Applicant: Seauto (Guangdong Hengqin) Technology Co., Ltd., Zhuhai City (CN)

(72) Inventors: Zhineng Deng, Zhuhai City (CN); Daliang Rong, Zhuhai City (CN)

(21) Appl. No.: 19/681,810

(22) Filed: May 19, 2026

Related U.S. Application Data
(63) Continuation of application No. PCT/CN2024/079437, filed on Feb. 29, 2024.

(30) Foreign Application Priority Data
Dec. 6, 2023 (CN) 202311660827.0

(51) Int. Cl. G05D 1/648; E04H 4/16; G05D 105/10; G05D 107/00

(52) U.S. Cl. CPC G05D 1/648; E04H 4/1654; G05D 2105/10; G05D 2107/29

(57) ABSTRACT

The present disclosure provides a method for cleaning a swimming pool wall, system, and medium. The method comprises: obtaining a distance between a swimming pool cleaning robot located on a pool bottom and a pool wall; determining whether the distance between the swimming pool cleaning robot and the pool wall satisfies a wall-climbing condition; in response to determining that the distance satisfies the wall-climbing condition, controlling the swimming pool cleaning robot to execute a wall-climbing strategy, wherein the wall-climbing strategy comprises controlling the swimming pool cleaning robot to climb along the pool wall to a waterline of the pool wall and cleaning a region of the pool wall over which the swimming pool cleaning robot climbs; and controlling the swimming pool cleaning robot to retreat from the waterline back to the pool bottom and to advance in a preset direction to a next position on the pool bottom.

### CROSS REFERENCE TO RELATED APPLICATIONS

The present application is a Continuation Application of PCT Application No. PCT/CN 2024/079437 filed on Feb. 29, 2024, which claims priority of Chinese Patent Application No. 202311660827.0 filed on Dec. 6, 2023, before CNIPA. All the above are hereby incorporated by reference in their entirety as part of the present disclosure.

### TECHNICAL FIELD

The present disclosure relates to the field of robotics, and in particular, to a method, system, and medium for cleaning a swimming pool wall.

### BACKGROUND

A pool cleaning robot is a household consumer robot used for cleaning a swimming pool. Its function is similar to that of a robotic vacuum cleaner. Unlike a robotic vacuum cleaner, however, a pool cleaning robot is used underwater and needs to operate in a swimming pool. Pool cleaning has long been a difficult task. Manual cleaning is cumbersome and time-consuming, and the industry has generally begun to use robots to clean swimming pools. Many companies are researching algorithms related to path planning, so that robots can clean a swimming pool along a preset route to achieve higher cleaning efficiency.

Some existing cleaning robots on the market do not have path planning and perform cleaning completely randomly, resulting in relatively low cleaning efficiency. Some cleaning robots with path planning are prone to traveling along repeated paths or becoming stuck at a certain location. This is because many robots cannot adapt to different wall surfaces. When a robot travels along a specific route, slipping or positional deviation is likely to occur, and when the robot encounters certain wall surfaces, the robot is prone to traveling along a repeated path, causing the robot to remain stuck in a specific region.

### SUMMARY

A main objective of the present disclosure is to provide a method, system, and medium for cleaning a swimming pool wall, so as to enable a swimming pool cleaning robot to continuously clean along swimming pool walls having different shapes, avoid repeated cleaning at the same location, and thereby improve swimming pool cleaning efficiency.

To achieve the foregoing objective, the present disclosure provides a method for cleaning a swimming pool wall, performed by a swimming pool cleaning robot. The method comprises the following steps:
step S10: obtaining a distance between the swimming pool cleaning robot located on a pool bottom and a pool wall;
step S20: determining whether the distance between the swimming pool cleaning robot and the pool wall satisfies a wall-climbing condition;
step S30: in response to determining that the distance satisfies the wall-climbing condition, controlling the swimming pool cleaning robot to execute a wall-climbing strategy, wherein the wall-climbing strategy comprises: controlling the swimming pool cleaning robot to climb along the pool wall to a waterline of the pool wall, and cleaning a region of the pool wall over which the swimming pool cleaning robot climbs;
step S40: controlling the swimming pool cleaning robot to retreat from the waterline back to the pool bottom and to advance in a preset direction to a next position on the pool bottom; and
step S50: returning to execute steps S10 to S40, so as to clean the pool wall in a next climbing region of the swimming pool cleaning robot.

In a further technical solution of the present disclosure, the wall-climbing condition is that the distance between the swimming pool cleaning robot located on the pool bottom and the pool wall is less than or equal to a first preset distance.

In a further technical solution of the present disclosure, the swimming pool cleaning robot comprises an ultrasonic probe at a front end thereof, and obtaining the distance between the swimming pool cleaning robot located on the pool bottom and the pool wall comprises:
detecting, with the ultrasonic probe, the distance between the swimming pool cleaning robot located on the pool bottom and the pool wall.

In a further technical solution of the present disclosure, the swimming pool cleaning robot comprises a water-pumping motor, a gyroscope, and an accelerometer. In step S30, controlling the swimming pool cleaning robot to execute the wall-climbing strategy, wherein the wall-climbing strategy comprises controlling the swimming pool cleaning robot to climb along the pool wall to the waterline of the pool wall and cleaning the region of the pool wall over which the swimming pool cleaning robot climbs, comprises:
step S301: deactivating the water-pumping motor and maintaining a forward speed, so that the swimming pool cleaning robot changes from a horizontal state to a vertical state when encountering the pool wall;
step S302: detecting an attitude of the swimming pool cleaning robot with the gyroscope and the accelerometer, and activating the water-pumping motor when the swimming pool cleaning robot reaches a substantially vertical state, so that the swimming pool cleaning robot presses against the pool wall and climbs upward along the pool wall; and
step S303: detecting a distance between the swimming pool cleaning robot and a water surface with the ultrasonic probe until the swimming pool cleaning robot climbs to the waterline, and causing the swimming pool cleaning robot to stay at the waterline for a first preset duration.

In a further technical solution of the present disclosure, step S40, controlling the swimming pool cleaning robot to retreat from the waterline back to the pool bottom and to advance in the preset direction to the next position on the pool bottom, comprises:
step S401: obtaining, from the gyroscope and the accelerometer, an angle between the swimming pool cleaning robot and the pool bottom, and determining, based on the angle, whether the swimming pool cleaning robot has returned to the pool bottom;
step S402: in response to determining that the swimming pool cleaning robot has returned to the pool bottom, controlling the swimming pool cleaning robot to continue moving backward for a second preset duration, so as to increase a distance from the pool wall; and
step S403: controlling the swimming pool cleaning robot to turn toward the preset direction by a predetermined angle, so as to advance the swimming pool cleaning robot to the next position on the pool bottom.

In a further technical solution of the present disclosure, step S402, controlling the swimming pool cleaning robot to continue moving backward for the second preset duration so as to increase the distance from the pool wall, further comprises:
when the swimming pool cleaning robot moves backward to a position at which a distance from the pool wall is a second preset distance, controlling the swimming pool cleaning robot to turn by 90°, and detecting, with the ultrasonic probe, whether a wall is present at a side of the swimming pool cleaning robot;
if yes, controlling the swimming pool cleaning robot to directly switch to another wall surface for cleaning when the swimming pool cleaning robot retreats next time; and
if no, controlling the swimming pool cleaning robot to turn again and turn back by 90° to return to a normal direction.

In a further technical solution of the present disclosure, before step S10, the method further comprises:
controlling the swimming pool cleaning robot to advance at a preset speed, without locking a traveling direction of the swimming pool cleaning robot during advancement.

In a further technical solution of the present disclosure, during cleaning of the pool wall by the swimming pool cleaning robot, when the pool wall is arcuate, the swimming pool cleaning robot climbs upward along a tangent to the pool wall.

To achieve the foregoing objective, the present disclosure further provides a swimming pool wall cleaning system. The system comprises a memory, a processor, and a swimming pool wall cleaning program stored in the memory, wherein the swimming pool wall cleaning program, when executed by the processor, causes the processor to perform the steps of the method described above.

To achieve the foregoing objective, the present disclosure further provides a non-transitory computer-readable storage medium. The non-transitory computer-readable storage medium stores a swimming pool wall cleaning program, wherein the swimming pool wall cleaning program, when executed by a processor, causes the processor to perform the steps of the method described above.

Beneficial effects of the swimming pool wall cleaning method, system, and medium of the present disclosure are as follows.

According to the technical solutions described above, the present disclosure obtains a distance between a swimming pool cleaning robot located on a pool bottom and a pool wall; determines whether the distance between the swimming pool cleaning robot and the pool wall satisfies a wall-climbing condition; in response to determining that the distance satisfies the wall-climbing condition, controls the swimming pool cleaning robot to execute a wall-climbing strategy, wherein the wall-climbing strategy comprises controlling the swimming pool cleaning robot to climb along the pool wall to a waterline of the pool wall and cleaning a region of the pool wall over which the swimming pool cleaning robot climbs; controls the swimming pool cleaning robot to retreat from the waterline back to the pool bottom and to advance in a preset direction to a next position on the pool bottom; and returns to execute the foregoing steps, so as to clean the pool wall in a next climbing region of the swimming pool cleaning robot. In this way, the swimming pool cleaning robot can continuously clean along pool walls having different shapes, repeated cleaning at the same location can be avoided, and swimming pool cleaning efficiency can be improved.

### BRIEF DESCRIPTION OF THE DRAWINGS

For a clearer description of the technical solutions in the embodiments of the present disclosure or in the prior art, the drawings used in the description of the embodiments or the prior art are briefly introduced below. It is apparent that the drawings described below show only some embodiments of the present disclosure, and a person of ordinary skill in the art may obtain other drawings based on the structures shown in these drawings without inventive effort.

FIG. 1 is an overall flowchart of a first embodiment of the swimming pool wall cleaning method according to the present disclosure;

FIG. 2 is a detailed flowchart of step S30;

FIG. 3 is a detailed flowchart of step S40;

FIG. 4 is a schematic diagram showing turning of the swimming pool cleaning robot.

The implementation of the objectives, functional features, and advantages of the present disclosure will be further described with reference to the embodiments and the accompanying drawings.

### DETAILED DESCRIPTION

The technical solutions in the embodiments of the present disclosure are clearly and completely described below with reference to the accompanying drawings in the embodiments of the present disclosure. Apparently, the described embodiments are merely some, rather than all, of the embodiments of the present disclosure. All other embodiments obtained by a person of ordinary skill in the art based on the embodiments of the present disclosure without inventive effort shall fall within the protection scope of the present disclosure.

The present disclosure provides a method for cleaning a swimming pool wall. The present disclosure is applied to a swimming pool wall cleaning robot. By using the swimming pool wall cleaning method of the present disclosure, the swimming pool cleaning robot can continuously clean along walls having different shapes, cleaning efficiency can be maintained as much as possible, and repeated cleaning by the swimming pool cleaning robot at the same location can be avoided.

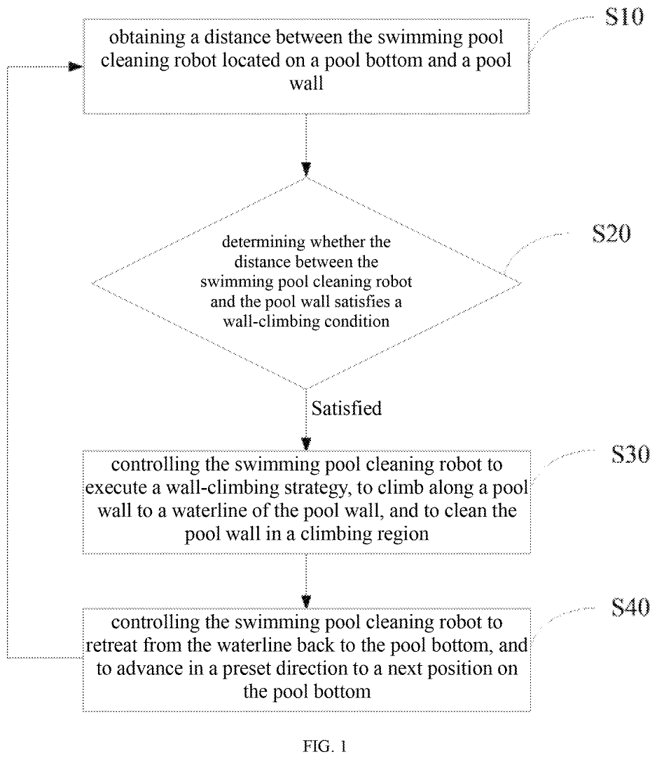

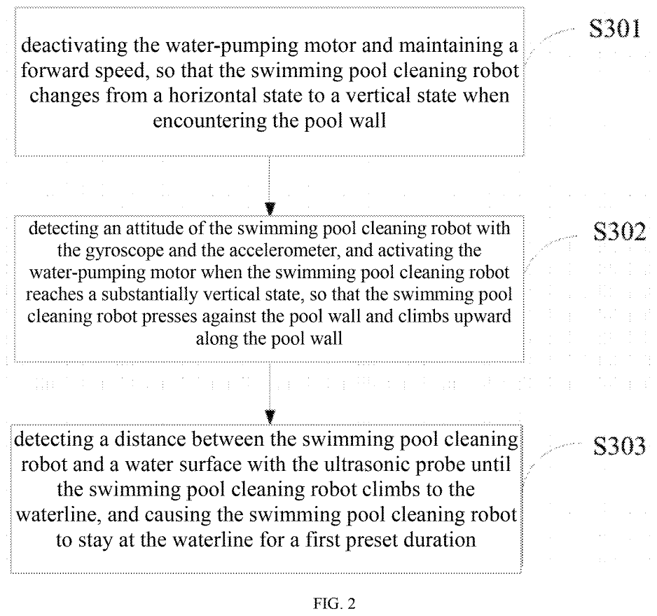

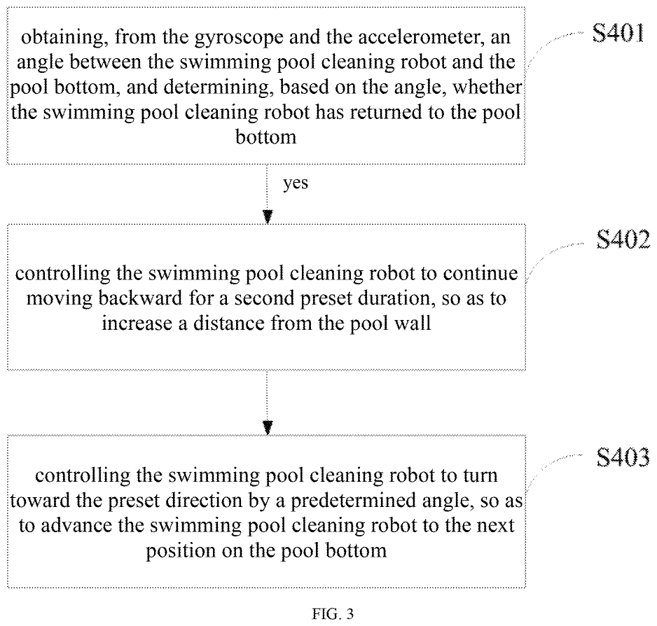

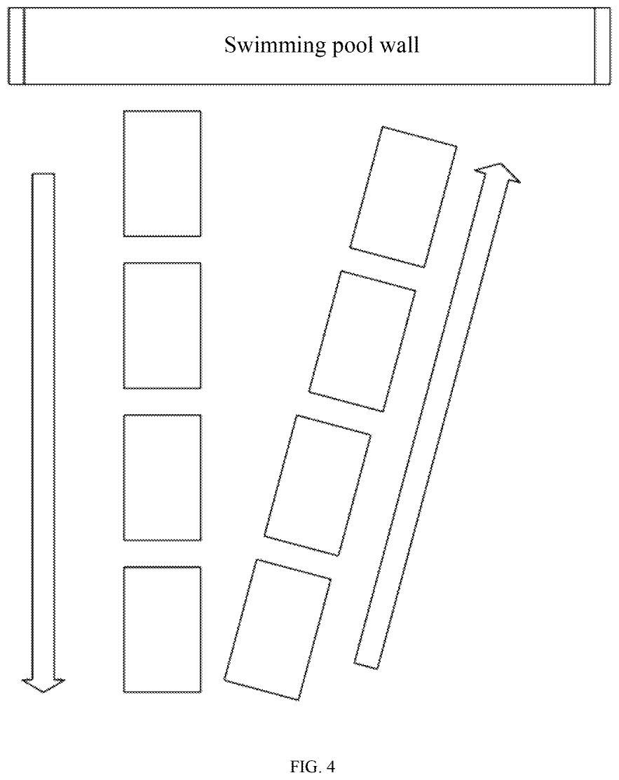

Referring to FIGS. 1 to 4, a preferred embodiment of the swimming pool wall cleaning method of the present disclosure comprises the following steps.

Step S10: obtaining a distance between a swimming pool cleaning robot located on a pool bottom and a pool wall.

In this embodiment, an ultrasonic probe is disposed at a front end of the swimming pool cleaning robot, and step S10 specifically comprises:
detecting, with the ultrasonic probe, the distance between the swimming pool cleaning robot located on the pool bottom and the pool wall.

Step S20: determining whether the distance between the swimming pool cleaning robot and the pool wall satisfies a wall-climbing condition.

In one implementation, in this embodiment, the wall-climbing condition is that the distance between the swimming pool cleaning robot located on the pool bottom and the pool wall is less than or equal to a first preset distance. The first preset distance may be set based on experience, for example, to 40 cm.

When the ultrasonic probe detects that the distance between the swimming pool cleaning robot and the pool wall is less than or equal to 40 cm, a wall-climbing strategy program is initiated.

Step S30: in response to determining that the distance satisfies the wall-climbing condition, controlling the swimming pool cleaning robot to execute a wall-climbing strategy. The wall-climbing strategy comprises controlling the swimming pool cleaning robot to climb along the pool wall to a waterline of the pool wall, and cleaning a region of the pool wall over which the swimming pool cleaning robot climbs.

In this embodiment, the swimming pool cleaning robot is provided with a water-pumping motor, a gyroscope, and an accelerometer. In step S30, controlling the swimming pool cleaning robot to execute the wall-climbing strategy, wherein the wall-climbing strategy comprises controlling the swimming pool cleaning robot to climb along the pool wall to the waterline of the pool wall and cleaning the region of the pool wall over which the swimming pool cleaning robot climbs, specifically comprises the following steps.

Step S301: deactivating the water-pumping motor and maintaining a forward speed, so that the swimming pool cleaning robot changes from a horizontal state to a vertical state when encountering the pool wall.

It should be noted that, in this embodiment, when the water-pumping motor is activated to pump water, negative pressure is generated between a bottom of the swimming pool cleaning robot and the pool bottom or the pool wall, so that the swimming pool cleaning robot stays against the pool bottom or the pool wall under pressure, thereby preventing the swimming pool cleaning robot from falling off the pool wall. When the water-pumping motor is deactivated to stop pumping water, the negative pressure between the bottom of the swimming pool cleaning robot and the pool bottom or the pool wall disappears.

Step S302: detecting an attitude of the swimming pool cleaning robot with the gyroscope and the accelerometer, and activating the water-pumping motor when the swimming pool cleaning robot reaches a substantially vertical state, so that the swimming pool cleaning robot presses against the pool wall and climbs upward along the pool wall.

After the gyroscope and the accelerometer detect that the attitude of the swimming pool cleaning robot changes from the horizontal state to the substantially vertical state, the water-pumping motor is activated to pump water, so that the swimming pool cleaning robot climbs upward while staying against the wall.

Step S303: detecting a distance between the swimming pool cleaning robot and a water surface with the ultrasonic probe until the swimming pool cleaning robot climbs to the waterline, and causing the swimming pool cleaning robot to stay at the waterline for a first preset duration.

After the swimming pool cleaning robot climbs upward while staying against the wall, the distance between the swimming pool cleaning robot and the water surface is detected with the ultrasonic probe until the swimming pool cleaning robot climbs to the waterline. When the distance is very small, the swimming pool cleaning robot has reached the waterline. The swimming pool cleaning robot stays at the waterline for 1 to 120 seconds.

Step S40: controlling the swimming pool cleaning robot to retreat from the waterline back to the pool bottom and to advance in a preset direction to a next position on the pool bottom.

After cleaning of the waterline is completed, the swimming pool cleaning robot starts to move backward, retreats from the waterline back to the pool bottom, and advances in the preset direction to the next position on the pool bottom.

Specifically, step S40 comprises the following steps.

Step S401: obtaining, from the gyroscope and the accelerometer, an angle between the swimming pool cleaning robot and the pool bottom, and determining, based on the angle, whether the swimming pool cleaning robot has returned to the pool bottom.

After cleaning of the waterline is completed, the swimming pool cleaning robot starts to move backward and retreats from the waterline. An angle calculated from fused data of the gyroscope and the accelerometer is used to determine whether the swimming pool cleaning robot has returned to the flat pool bottom. When the swimming pool cleaning robot has returned to the flat pool bottom, an angle between a plane of a bottom of the swimming pool cleaning robot and a plane of the pool bottom is 0 degrees.

Step S402: in response to determining that the swimming pool cleaning robot has returned to the pool bottom, controlling the swimming pool cleaning robot to continue moving backward for a second preset duration, so as to increase a distance from the pool wall.

The second preset duration may be set based on actual experience, for example, to 1 to 30 seconds. In this embodiment, the purpose of controlling the swimming pool cleaning robot to continue moving backward for the second preset duration is to increase the distance between the swimming pool cleaning robot and the pool wall, thereby facilitating the swimming pool cleaning robot in handling different obstacles or walls.

Step S403: controlling the swimming pool cleaning robot to turn toward the preset direction by a predetermined angle, so as to advance the swimming pool cleaning robot to the next position on the pool bottom.

After the swimming pool cleaning robot continues moving backward for the second preset duration, the swimming pool cleaning robot is controlled to turn toward the preset direction by a predetermined angle, for example, to turn left or right by 5° to 45°, so as to switch to a next location on the wall for cleaning.

Step S50: returning to execute steps S10 to S40, so as to clean the pool wall in a next climbing region of the swimming pool cleaning robot.

Further, in this embodiment, after step S402 of controlling the swimming pool cleaning robot to continue moving backward for the second preset duration so as to increase the distance from the pool wall, the method further comprises:
when the swimming pool cleaning robot moves backward to a position at which a distance from the pool wall is a second preset distance, controlling the swimming pool cleaning robot to turn by 90°, and detecting, with the ultrasonic probe, whether a wall is present at a side of the swimming pool cleaning robot,
if yes, the swimming pool cleaning robot directly switches to another wall surface for cleaning when the swimming pool cleaning robot retreats next time.
if no, the swimming pool cleaning robot is controlled to turn again and turn back by 90° to return to a normal direction.

In this embodiment, when the swimming pool cleaning robot retreats to the pool bottom and is at a certain distance from the pool wall, the swimming pool cleaning robot is controlled to turn by 90°, and ultrasound is used to detect whether a wall is present at a side of the swimming pool cleaning robot. If a wall is present, the swimming pool cleaning robot directly switches to another wall surface for cleaning when the swimming pool cleaning robot retreats next time. After detection is completed, the swimming pool cleaning robot is controlled to turn again to return to the normal direction and continue executing the original program. The operation of detecting the wall may be performed each time, or may be performed once after a greater number of times. The present disclosure is not limited thereto.

Further, in this embodiment, before step S10, the method further comprises: controlling the swimming pool cleaning robot to advance at a preset speed, without locking a traveling direction of the swimming pool cleaning robot during advancement.

In this embodiment, during cleaning of the pool wall by the swimming pool cleaning robot, when the pool wall is arcuate, the swimming pool cleaning robot climbs upward along a tangent to the pool wall.

In this embodiment, the swimming pool cleaning robot is caused to move in a preset direction by changing by a certain angle. Regardless of whether the wall is flat, arcuate, or otherwise irregularly shaped, the swimming pool cleaning robot can smoothly advance for cleaning. Each time the swimming pool cleaning robot climbs onto the wall, the swimming pool cleaning robot climbs upward along a tangent to the wall, thereby implementing a function of adapting to different walls.

The beneficial effects of the swimming pool wall cleaning method of the present disclosure are as follows.

According to the technical solutions described above, the present disclosure obtains a distance between a swimming pool cleaning robot located on a pool bottom and a pool wall; determines whether the distance between the swimming pool cleaning robot and the pool wall satisfies a wall-climbing condition; in response to determining that the distance satisfies the wall-climbing condition, controls the swimming pool cleaning robot to execute a wall-climbing strategy, wherein the wall-climbing strategy comprises controlling the swimming pool cleaning robot to climb along the pool wall to a waterline of the pool wall and cleaning a region of the pool wall over which the swimming pool cleaning robot climbs; controls the swimming pool cleaning robot to retreat from the waterline back to the pool bottom and to advance in a preset direction to a next position on the pool bottom; and returns to execute the foregoing steps, so as to clean the pool wall in a next climbing region of the swimming pool cleaning robot. In this way, the swimming pool cleaning robot can continuously clean along pool walls having different shapes, repeated cleaning at the same location can be avoided, and swimming pool cleaning efficiency can be improved.

To achieve the foregoing objective, the present disclosure further provides a swimming pool wall cleaning system. The system comprises a memory, a processor, and a swimming pool wall cleaning program stored in the memory. When executed by the processor, the swimming pool wall cleaning program causes the processor to perform the steps of the method described above, and details are not repeated herein.

To achieve the foregoing objective, the present disclosure further provides a non-transitory computer-readable storage medium. The non-transitory computer-readable storage medium stores a swimming pool wall cleaning program. When executed by a processor, the swimming pool wall cleaning program causes the processor to perform the steps of the method described above, and details are not repeated herein.

The above descriptions are merely preferred embodiments of the present disclosure and are not intended to limit the patent scope of the present disclosure. Any equivalent structural changes made based on the contents of the specification and drawings of the present disclosure under the concept of the present disclosure, or any direct or indirect application thereof in other related technical fields, shall fall within the patent protection scope of the present disclosure.

1. A method for cleaning a swimming pool wall, performed by a swimming pool cleaning robot, the method comprising:
step S10: obtaining a distance between the swimming pool cleaning robot located on a pool bottom and a pool wall;
step S20: determining whether the distance between the swimming pool cleaning robot and the pool wall satisfies a wall-climbing condition;
step S30: in response to determining that the distance satisfies the wall-climbing condition, controlling the swimming pool cleaning robot to execute a wall-climbing strategy, wherein the wall-climbing strategy comprises: controlling the swimming pool cleaning robot to climb along the pool wall to a waterline of the pool wall, and cleaning a region of the pool wall over which the swimming pool cleaning robot climbs;
step S40: controlling the swimming pool cleaning robot to retreat from the waterline back to the pool bottom, and to advance in a preset direction to a next position on the pool bottom; and
step S50: returning to execute steps S10 to S40, so as to clean the pool wall in a next climbing region of the swimming pool cleaning robot.

2. The method for cleaning a swimming pool wall of claim 1, wherein the wall-climbing condition is that the distance between the swimming pool cleaning robot located on the pool bottom and the pool wall is less than or equal to a first preset distance.

3. The method for cleaning a swimming pool wall of claim 1, wherein an ultrasonic probe is disposed at a front end of the swimming pool cleaning robot, and obtaining the distance between the swimming pool cleaning robot located on the pool bottom and the pool wall comprises:
detecting, with the ultrasonic probe, the distance between the swimming pool cleaning robot located on the pool bottom and the pool wall.

4. The method for cleaning a swimming pool wall of claim 3, wherein a water-pumping motor, a gyroscope, and an accelerometer are disposed in the swimming pool cleaning robot, and in step S30, controlling the swimming pool cleaning robot to execute the wall-climbing strategy, wherein the wall-climbing strategy comprises controlling the swimming pool cleaning robot to climb along the pool wall to the waterline of the pool wall and cleaning the region of the pool wall over which the swimming pool cleaning robot climbs, comprises:
step S301: deactivating the water-pumping motor and maintaining a forward speed, so that the swimming pool cleaning robot changes from a horizontal state to a vertical state when encountering the pool wall;
step S302: detecting an attitude of the swimming pool cleaning robot with the gyroscope and the accelerometer, and activating the water-pumping motor when the swimming pool cleaning robot reaches a substantially vertical state, so that the swimming pool cleaning robot presses against the pool wall and climbs upward along the pool wall; and
step S303: detecting a distance between the swimming pool cleaning robot and a water surface with the ultrasonic probe until the swimming pool cleaning robot climbs to the waterline, and causing the swimming pool cleaning robot to stay at the waterline for a first preset duration.

5. The method for cleaning a swimming pool wall of claim 4, wherein step S40, controlling the swimming pool cleaning robot to retreat from the waterline back to the pool bottom and to advance in the preset direction to the next position on the pool bottom, comprises:
step S401: obtaining, from the gyroscope and the accelerometer, an angle between the swimming pool cleaning robot and the pool bottom, and determining, based on the angle, whether the swimming pool cleaning robot has returned to the pool bottom;
step S402: in response to determining that the swimming pool cleaning robot has returned to the pool bottom, controlling the swimming pool cleaning robot to continue moving backward for a second preset duration, so as to increase a distance from the pool wall; and
step S403: controlling the swimming pool cleaning robot to turn toward the preset direction by a predetermined angle, so as to advance the swimming pool cleaning robot to the next position on the pool bottom.

6. The method for cleaning a swimming pool wall of claim 5, wherein step S402, controlling the swimming pool cleaning robot to continue moving backward for the second preset duration so as to increase the distance from the pool wall, further comprises:
when the swimming pool cleaning robot moves backward to a position at which a distance from the pool wall is a second preset distance, controlling the swimming pool cleaning robot to turn by 90°, and detecting, with the ultrasonic probe, whether a wall is present at a side of the swimming pool cleaning robot;
if yes, controlling the swimming pool cleaning robot to directly switch to another wall surface for cleaning when the swimming pool cleaning robot retreats next time;
if no, controlling the swimming pool cleaning robot to turn again and turn back by 90° to return to a normal direction.

7. The method for cleaning a swimming pool wall of claim 1, further comprising, before step S10:
controlling the swimming pool cleaning robot to advance at a preset speed, without locking a traveling direction of the swimming pool cleaning robot during advancement.

8. The method for cleaning a swimming pool wall of claim 7, wherein, during cleaning of the pool wall by the swimming pool cleaning robot, when the pool wall is arcuate, the swimming pool cleaning robot climbs upward along a tangent to the pool wall.

9. A swimming pool wall cleaning system, comprising a memory, a processor, and a swimming pool wall cleaning program stored on the processor, wherein the swimming pool wall cleaning program, when executed by the processor, causes the processor to perform the steps of the method of claim 1.

10. A non-transitory computer-readable storage medium, storing a swimming pool wall cleaning program, wherein the swimming pool wall cleaning program, when executed by a processor, causes the processor to perform the steps of the method of claim 1. .
